(19) United States
(12) Patent Application Publication
(10) Pub. No.: US 2024/0361212 A1
(43) Pub. Date: Oct. 31, 2024

(54) SYSTEMS AND METHODS FOR TISSUE STAINING

(71) Applicants: RENSSELAER POLYTECHNIC INSTITUTE, Troy, NY (US); SURGIVANCE, INC., New York, NY (US)

(72) Inventors: Daniel Summer Gareau, New York, NY (US); Cassidy Sheehan, Stillwater, NY (US); Chloe Lewandowski, Glenville, NY (US); Axel Batlle, Nunda, NY (US); Isabell Devereaux, Staten Island, NY (US); Samuel Harrington, West Hartford, CT (US)

(21) Appl. No.: 18/646,604

(22) Filed: Apr. 25, 2024

Related U.S. Application Data
(60) Provisional application No. 63/522,542, filed on Jun. 22, 2023.
(60) Provisional application No. 63/462,033, filed on Apr. 26, 2023.
(60) Provisional application No. 63/461,687, filed on Apr. 25, 2023.

(51) Int. Cl. G01N 1/31

(52) U.S. Cl. CPC G01N 1/31

(57) ABSTRACT

A system for tissue staining includes an upper housing, a lower housing, and a microscope lens. The upper housing includes a first reservoir configured to retain a solution therein, a valve attached to the reservoir including a turning knob, a first conduit configured to transport the solution, and a funnel fluidly connected to the first conduit. The lower housing is threadedly couped to the upper housing. The lower housing includes a top cassette portion having a window, a bottom cassette portion having a recess configured to retain a tissue therein, and a gasket disposed along an outer perimeter of the bottom cassette portion. The upper portion and the lower housing are coupled via threading. The microscope lens is configured to image the tissue through the window.

### CROSS REFERENCE TO RELATED APPLICATIONS

The present application claims the benefit of and priority to U.S. Provisional Patent Application No. 63/522,542, filed on Jun. 22, 2023, U.S. Provisional Patent Application No. 63/462,033, filed on Apr. 26, 2023, and U.S. Provisional Patent Application No. 63/461,687, filed on Apr. 25, 2023, the entire contents of each of which are hereby incorporated by reference in entirety.

### TECHNICAL FIELD

The present disclosure relates to systems and methods for tissue staining, and, more specifically, to systems and methods for tissue staining using a tissue staining apparatus.

### BACKGROUND

Tissue staining is a fundamental practice in the field of histology, which highlights tissue characteristics through the enhancement of the tissue's natural contrast. Once a tissue sample has undergone staining, it can then be further analyzed through microscopy for interpretation by a pathologist for the purposes of, for example, medical diagnosis and forensic investigation.

Many traditional tissue staining systems utilize external input, or power sources, that can increase the potential for complications if they were to malfunction. Additionally, the use of said external inputs and power sources make for an immobile system that cannot be easily moved to be utilized on a wide variety of surfaces and in a variety of settings. The plethora of external parts associated with traditional tissue staining systems lend hand to costly manufacturing processes and unaffordable systems, primarily for doctors and trained professionals who operate in areas with fewer resources and training opportunities.

Accordingly, there is a continuing need for gravity-based systems involving self-contained and disposable staining of tissue for use in confocal microscopy.

### SUMMARY

In accordance with an aspect of the present disclosure, a system for tissue staining includes an upper housing, a lower housing, and a microscope lens. The upper housing includes a first reservoir configured to retain a solution therein, a valve attached to the reservoir including a turning knob, a first conduit configured to transport the solution, and a funnel fluidly connected to the first conduit. The lower housing is threadedly couped to the upper housing. The lower housing includes a top cassette portion having a window, a bottom cassette portion having a recess configured to retain a tissue therein, and a gasket disposed along an outer perimeter of the bottom cassette portion. The upper portion and the lower housing are coupled via threading. The microscope lens is configured to image the tissue through the window.

In another aspect of the present disclosure, the valve may be a two-way Y-valve.

In yet another aspect of the present disclosure, the first reservoir may be configured to retain a stain solution for staining the tissue.

In a further aspect of the present disclosure, a second reservoir may be configured to retain a rinse for rinsing excess stain solution from the tissue.

In yet a further aspect of the present disclosure, the first reservoir nay be pre-filled with an acridine orange stain solution, and the second reservoir may be pre-filled with a phosphate-buffered saline rinse solution.

In another aspect of the present disclosure, the system may include a cooler configured to maintain a preset temperature within the lower housing.

In yet another aspect of the present disclosure, the recess may include a gel configured to adhere to tissue to the recess and maintain a position of the tissue therein. The gel may include agarose, formaldehyde, and/or dimethyl sulfoxide.

In a further aspect of the present disclosure, the top cassette portion may be configured to compress the tissue along an upper surface of the bottom cassette portion.

In yet a further aspect of the present disclosure, the window may be flush with the top surface of the bottom cassette portion.

In another aspect of the present disclosure 1, the funnel may include a mesh guard configured to retain the tissue within the cassette.

In accordance with an aspect of the present disclosure, a method of imaging tissue using a tissue staining apparatus includes: filling a first reservoir and a second reservoir with a stain and a rinse, respectively; connecting first and second housings of a tissue staining apparatus; releasing the stain from the first reservoir via a valve, the stain configured to stain a tissue housed on the second housing of the tissue staining apparatus; releasing the rinse from the second reservoir via the valve, the rinse configured to rinse the stained tissue; disconnecting the first and second housing of the tissue staining apparatus; placing a lid onto the second housing of the tissue staining apparatus to compress the stained tissue in a recess therein; and imaging the compressed tissue using a microscope.

In another aspect of the present disclosure, the valve may be a two-way Y-valve.

In yet another aspect of the present disclosure, valve may be configured to release the stain using a first turning knob, and the valve may be configured to release the rinse using a second turning knob.

In a further aspect of the present disclosure, the stain may be configured to flow through a first conduit, and the rinse may be configured to flow through a second conduit.

In yet a further aspect of the present disclosure, the first reservoir may be filled with an acridine orange stain solution, and the second reservoir may be filled with a phosphate-buffered saline rinse solution.

In another aspect of the present disclosure, the recess may include a gel configured to adhere to tissue to the recess and maintain a position of the tissue therein. The gel may include of agarose, formaldehyde, and/or dimethyl sulfoxide.

In yet another aspect of the present disclosure, the second housing of the tissue staining apparatus may be a bottom cassette portion.

In a further aspect of the present disclosure, the lid may include a window flush with a top surface of the bottom cassette portion.

In yet a further aspect of the present disclosure, the method may include: inverting the tissue staining apparatus to drain the stain and the rinse back into the first and second reservoirs, respectively.

In accordance with an aspect of the present disclosure, a tissue staining apparatus includes: a first reservoir configured to retain a stain solution therein; a second reservoir configured to retain a rinse solution therein; a valve attached to the first and second reservoirs, the valve configured to release the stain solution through a first conduit and release the rinse solution through a second conduit; and a cassette having a recess configured to retain a tissue therein, the cassette configured to receive the stain solution and the rinse solution.

Further details and aspects of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying figures of which:

FIG. 1 is an exploded view of a tissue staining system, in accordance with aspects of the present disclosure;

FIG. 2 is a cross-sectional view of a reservoir for use with the tissue staining system of FIG. 1, in accordance with aspects of the present disclosure;

FIG. 3 is a side perspective view of an upper portion of the tissue staining system of FIG. 1, with the reservoirs removed, in accordance with aspects of the present disclosure;

FIG. 4 is a side perspective view of the tissue staining system of FIG. 1, in accordance with aspects of the present disclosure;

FIGS. 5A and 5B are a side perspective view and a bottom perspective view, respectively, of a funnel for use with the tissue staining system of FIG. 1, in accordance with aspects of the present disclosure;

FIG. 6 is an exploded view of a cassette for use with the tissue staining system of FIG. 1, in accordance with aspects of the present disclosure;

FIG. 7 is side perspective view of the cassette of FIG. 6 with the cover removed, in accordance with aspects of the present disclosure;

FIG. 8 is side perspective view of the cassette of FIG. 6, in accordance with aspects of the present disclosure;

FIG. 9 is side view of a tissue staining system, in accordance with aspects of the present disclosure;

FIG. 10 is a side perspective view of a valve assembly for use with the tissue staining system of FIG. 9, in accordance with aspects of the present disclosure;

FIG. 11 is a side perspective view of a central portion of the tissue staining system of FIG. 9, in accordance with aspects of the present disclosure;

FIG. 12 is an exemplary cassette for use with the tissue staining system of FIG. 9, in accordance with aspects of the present disclosure;

FIG. 13 is an exemplary use of a cover with the tissue staining system of FIG. 9, in accordance with aspects of the present disclosure;

FIG. 14 is flow diagram of an exemplary use of the tissue staining systems of FIGS. 1 and 9, in accordance with aspects of the present disclosure;

FIG. 15 is side perspective view of a tissue staining system, in accordance with aspects of the present disclosure;

FIG. 16 is a side perspective view of an arm for use with the tissue staining system of FIG. 15, in accordance with aspects of the present disclosure;

FIGS. 17A and 17B are exemplary end effectors of the arm of FIG. 16, in accordance with aspects of the present disclosure;

FIG. 18 is a block diagram of example components of the controller, in accordance with aspects of the present disclosure;

FIG. 19 is a block diagram of a machine learning network with inputs and outputs of a deep learning neural network, in accordance with aspects of the present disclosure;

FIG. 20 is a diagram of layers of the machine learning network of FIG. 19, in accordance with aspects of the present disclosure;

FIGS. 21 and 22 illustrate exemplary imaging of stained tissue, in accordance with aspects of the present disclosure;

FIG. 23 is a top perspective view of another exemplary cassette for use with the tissue staining systems of FIGS. 1, 9, and 15, in accordance with aspects of the present disclosure; and

FIGS. 24a, 24b, and 24c are various views of the cassette of FIG. 23, in accordance with aspects of the present disclosure.

### DETAILED DESCRIPTION

The present disclosure relates to systems and methods for tissue staining, and, more specifically, to systems and methods for tissue staining using a self-contained, gravity-based tissue staining apparatus, which may be used in confocal microscopy. Aspects of the present disclosure are described in detail with reference to the figures wherein like reference numerals identify similar or identical elements.

As used herein, “confocal microscopy” refers to an advanced imaging technique, which is used in biology, materials science, and/or other fields to obtain high-resolution images of samples. Confocal microscopy offers many advantages over traditional widefield microscopy, including improved contrast, increased resolution, and the ability to optically section specimens in three dimensions. Generally, a focused laser beam is used to scan the specimen point by point, allowing precise control over the illumination of the sample. A pinhole aperture may be placed in front of the detector to reject out-of-focus light, such that only light emitted or reflected from the focal plane of the specimen passes through the pinhole and is detected, resulting in improved optical sectioning and increased contrast. By scanning through different focal planes of the specimen, confocal microscopy can generate optical sections at different depths. This ability to optically section the specimen in three dimensions allows for the reconstruction of detailed 3D images of biological samples or other specimens.

Confocal microscopy is often used in conjunction with fluorescent labeling techniques, such as various staining techniques. Fluorescently labeled molecules or structures within the specimen emit light when illuminated with specific wavelengths of light. By using appropriate filters and detectors, confocal microscopy can selectively capture the emitted fluorescence signals, enabling the visualization of specific cellular structures or molecules within the specimen. The process of staining samples is discussed herein.

As used herein, “tissue” may include any type of tissue capable of being imaged. For example, tissue may refer to a group or cells and/or cells organized into a larger structure, such as an organ. For example, tissue may encompass animal tissue, such as epithelial tissue, connective tissue (e.g., blood), muscle tissue, and/or nervous tissue. In another example, tissue may encompass plant tissue, such as dermal tissue, ground tissue, and/or vascular tissue.

As used herein, “stain” may include any substance applied to samples (e.g., biological samples) to enhance their visibility or highlight specific structures under a microscope. This stain may be used in to differentiate between different cell types, visualize cellular structures, or identify specific molecules within cells or tissues. For example, the stain may be used in confocal microscopy to identify specific tumors on tissue. Different types of stains may be used based on the properties of the target portion of the sample (e.g., acridine orange stain) as described further below.

As used herein, “rinse” may include any substance applied to samples (e.g., biological samples) to clean or remove residue, such as stain residue. For example, the rinse may be used in confocal microscopy to ensure that a surface of the tissue is thoroughly cleaned and free of residual stain, which can impact the imaging process. The rinse may include various buffer solutions and/or distilled water, based on the properties of the target portion of the sample (e.g., Phosphate-Buffered saline (PBS)) as described further below.

Although the present disclosure will be described in terms of specific aspects and examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the figures, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

The systems and methods for tissue staining discussed herein provides various benefits over the current technology. The systems are and methods are designed to provide fully contained staining solutions, many of which utilize a regulated flow of liquid between two upper receptacles (e.g., reservoirs) through the use of gravity and valve designs. The simplicity of design and/or integration, the small size, and ease of use require minimal training to produce a stained and rinsed sample. Further, the contained system reduces exposure to toxic chemicals. Furthermore, manufacturers may use a simple, inexpensive injection molding process, which is easily scalable. In addition, there is no need for external input and/or power sources, thereby reducing the potential for complications during use.

Moreover, the system is portable and may be used on any surface. This flexibility makes the systems desirable for a surgical setting, with the ability to customize and/or further improve the systems for specific usage using varied controlled flow. For example, portions of the system may be removable for a histopathology lab. Thus, the system may enable tissue preparation and/or imaging of tissue at the point-of-care, e.g., within the operating room itself, further decreasing cost while increasing accessibility. Further, the elimination of preparation steps decreases overall processing time for staining.

Overall, the financial advantages and simple, manual design makes the systems and methods herein more accessible to doctors and/or other trained professionals in areas with fewer resources, while also providing accessible training opportunities.

The tissue staining system disclosed herein is described for use with a biological sample, which may include any material derived from a living organism that is used for scientific analysis, experimentation, and/or diagnostic purposes. A biological samples can encompass a wide range of materials, including tissues, cells, fluids, organs, and organisms themselves. For example, the tissue staining system may be used to stain tissues, cells, blood, serum, bodily fluids, DNA, RNA, microorganisms, plant components, and/or animal models, and/or environmental samples. However, it will be understood that the tissue staining system may be used with a variety of non-living specimen, such as inorganic materials including minerals, metals, metalloids, ceramics, glasses, semiconductors, salts and/or oxides.

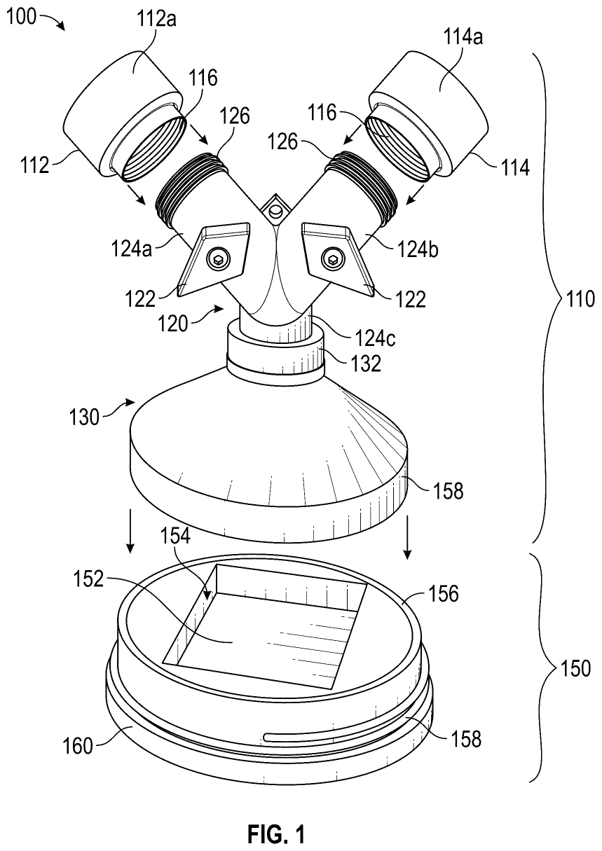

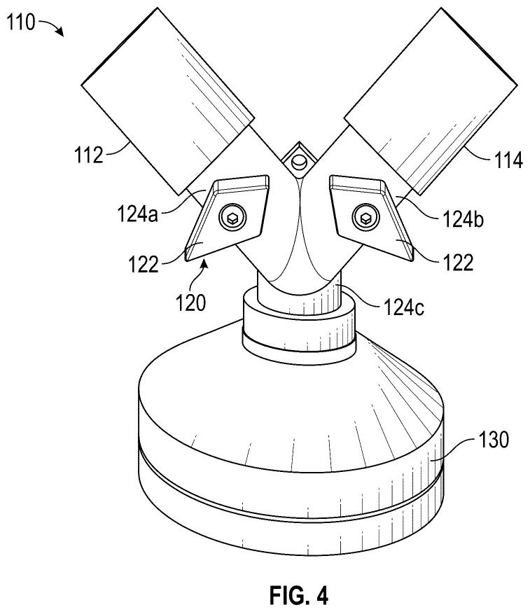

Referring to FIGS. 1-8, a tissue staining system 100 is shown according to aspects of the present disclosure. Tissue staining system 100 generally includes an upper portion 110, (e.g., a liquid delivery system) and a lower portion, e.g., cassette 150 (e.g., a fixation system). Tissue staining system 100 is configured to regulate the flow of a substance through a combination of gravity and a valve design. In aspects, upper portion 110 and cassette 150 may be manually attached to and/or separated via threading 158.

Upper portion 110 may be utilized as a liquid delivery system. Upper portion 110 includes multiple reservoirs, each configured to retain and/or deliver a substance (e.g., a liquid or gas), such as reservoirs 112 and 114. Each reservoir 112, 114 may be configured to maintain separation of a different substance or may each contain the same substance. In aspects, reservoirs 112, 114 may be pre-filled before assembly.

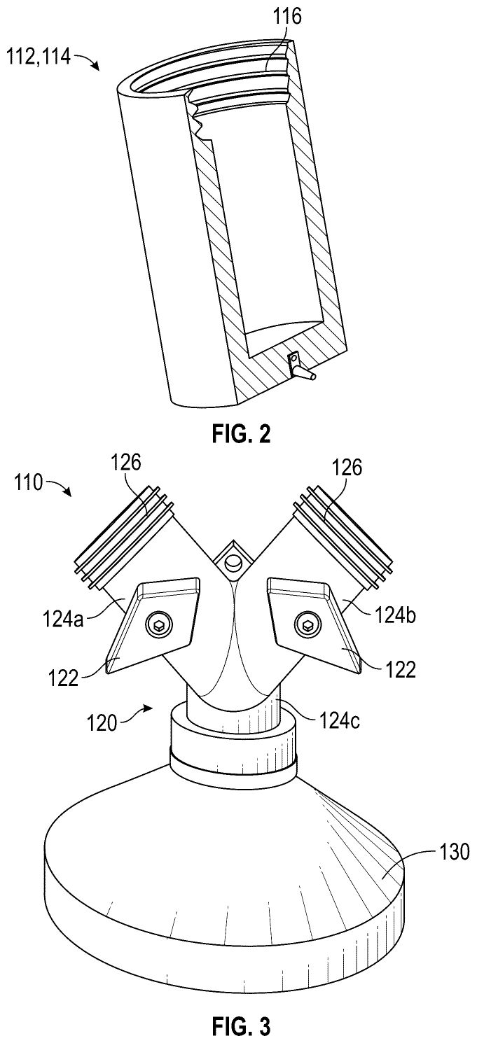

As shown in FIG. 2. each reservoir reservoirs 112 and 114 may be between approximately 25-45 mm, such as 35 mm, in volume. For example, each reservoir 112, 114 may have a height between approximately 30-50 mm (e.g., 39.68 mm), an inner diameter between approximately 10-30 mm (e.g., 20 mm), and/or an outer diameter between approximately 20-40 mm (e.g., 30 mm) It will be understood that the overall dimensions of each reservoir 112, 114 may vary based on the specific imaging setup, the type of sample being imaged, and/or the experimental requirements. For example, various factors may influence volumetric requirements, including total solution required, minimization of evaporation, compatibility of lenses, ease of handling, optical quality, and/or contamination control. In aspects, reservoirs 112 and 114 may be configured to contain potentially toxic substances and/or may be leak proof. In aspects, reservoirs 112 and 114 may include straining grates configured to modulate the flow of a substance therethrough, such as stain 112a and/or rinse 114a (discussed below).

In aspects, reservoir 112 may contain a stain and/or fluorophore (e.g., stain) 112a, which may be used to label (e.g., stain) a portion of a biological sample, e.g., tissue 152, including specific structures and/or molecules thereof. The stain 112a may be chosen based on the properties of the target portion of the sample (e.g., and/or the desired imaging outcomes. Generally, reservoir 112 contains a versatile nucleic acid stain 112a such as acridine orange, although it is contemplated that various stains 112a may be used, including fluorescein isothiocyanate (FITC), tetramethylrhodamine (TRITC), Alexa Fluor dyes, 4′,6-Diamidino-2-Phenylindole (DAPI), 1,1′-Dioctadecyl-3,3,3′,3′-Tetramethylindocarbocyanine Perchlorate (Dil), Hoechst dyes, phalloidin, and/or Calcein-AM. The acridine orange stain 112a used may be at a pH of 6.0.

In aspects, reservoir 114 may contain a solution and/or rinse 114a, which may be used to wash the tissue 152 after labeling and/or staining thereof. The solution and/or rinse 114a may be chosen based on factors such as the nature of the sample, the staining or labeling protocol being used, and/or the desired imaging outcomes. For example, a rinse 114a may include various buffer solutions and/or distilled water, which serve to remove excess staining reagents, reduce background fluorescence, and/or maintain sample integrity during imaging. Generally, reservoir 114 contains Phosphate-Buffered saline (PBS), which includes phosphate salts and sodium chloride dissolved in water and has a neutral pH, although various solutions and/or rinses 114a are contemplated, including tris-buffered saline (TBS), 4-2-hydroxyethyl-1-piperazineethanesulfonic acid (HEPES)-buffered saline, distilled water, and/or sterile water.

With further reference to FIGS. 3-5B, reservoirs 112, 114 may be connected to a valve 120. Generally, valve 120 is a standard two-way valve, although alternative configurations are contemplated including tee valves, ball valves, and/or multi-port valves. Reservoirs 112, 114 are typically threadedly coupled to valve 120, although alternative attachment methods are contemplated. For example, reservoirs 112, 114 may each include between approximately 0.25-1.25 in in threading 116 (e.g., garden hose threading) formed on an inner surface thereof, which may be configured to mate with female threading 126 of valve 120. valve 120 may include turning knobs 122 configured to open and/or close valve 120. Turning knobs 122 may be attached to valve 120 via threading, soldering, adhesives, and/or other attachment methods. While pictured as knob handles, alternative handle types for turning knobs 122 are contemplated, including level handles, T-handles, wheel handles, wrench-operated handles, gear-operated handles, and/or pneumatic or electric actuators.

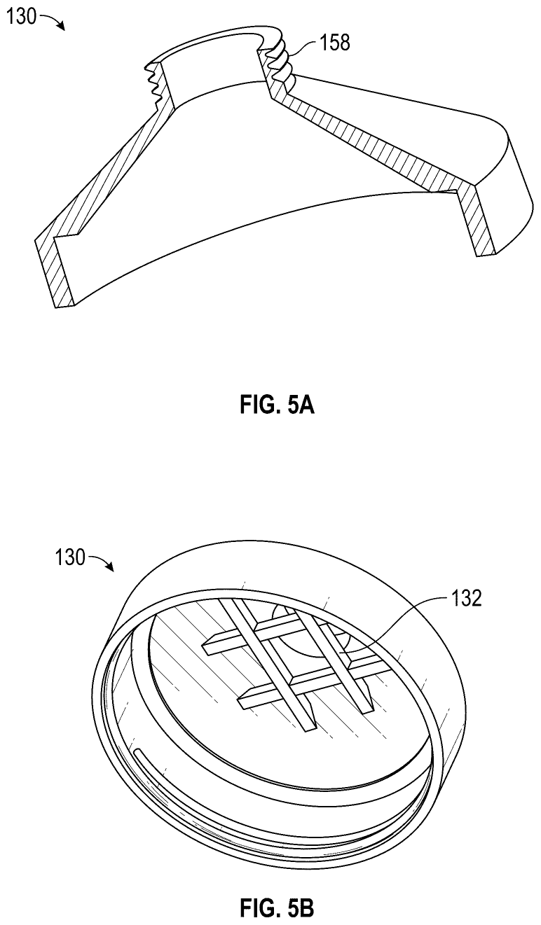

Generally, valve 120 operates with three conduits 124a-124c, which connect to form a Y-shape, although alternative structures are contemplated. Similar to turning knobs 122, valve 120 may be connected to conduits 124a-124c via threading, soldering, adhesives, and/or other attachment methods. Generally, conduit 124a may be fluidly connected to reservoir 112 and conduit 124b may be fluidly connected to reservoir 114. Conduits 124a and 124b may converge at valve 120, permitting passage of a substance therethrough into conduit 124c or vice versa. Conduit 124c may be fluidly connected to a funnel 130 via threading 158 (FIG. 5A), which empties the substance onto cassette 150. In aspects, funnel 130 may include a mesh guard 132 (FIG. 5B) configured to prevent the tissue 152 from entering conduits 124a-c and/or reservoirs 112, 114 if disconnected from cassette 150 (e.g., dislodged from gel 154, which is discussed further below).

In use, each reservoir 112, 114 is filled with the desired substance and attached to (e.g., screwed onto) valve 120 while closed and upper portion 110 is connected to lower portion, e.g., cassette 150. The substance may be released from each reservoir 112, 114 by opening valve 120 using turning knobs 122. For example, rotating turning knobs 122 counterclockwise may turn valve 120 inward towards an open position. Overall, the configuration of upper portion 110 provides a benefit over current technology by allowing for a simplistic, user-controlled release of a substance onto tissue 152. For example, once a stain 112a is released onto tissue 152, the user may allow the stain 112a to sit on the tissue 152, invert tissue staining system 100 to drain the stain 112a back into reservoir 112, and/or close valve 120 prior to turning the tissue staining system 100 right-side up. The process may be repeated for reservoir 114 to rinse tissue 152. Thereafter, upper portion 110 may be disconnected from cassette 150, which is safe for handling after the rinsing of tissue 152.

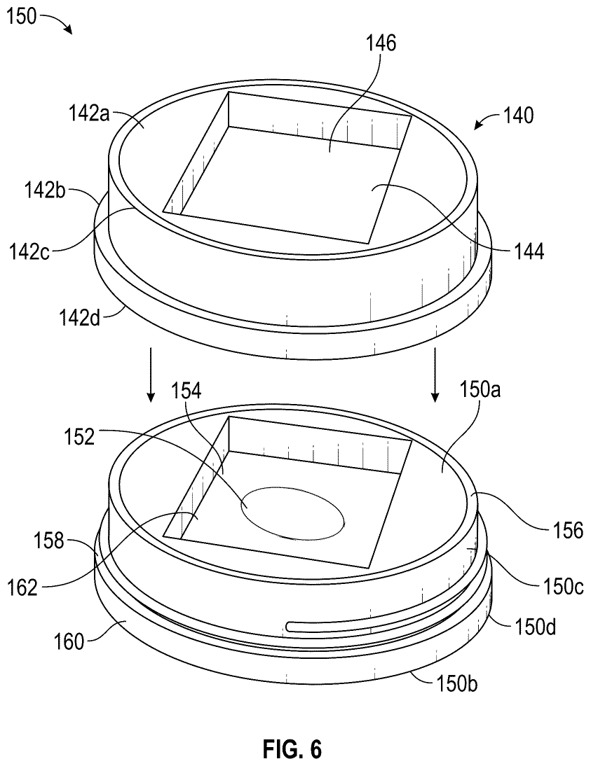

Now referring to FIGS. 6-8, cassette 150 includes an upper surface 150a, a lower surface 150b, a first outer perimeter 150c, a second outer perimeter 150d, tissue 152, gel 154, gasket 156, threading 158, grip 160, and/or recess 162. Tissue 152 may include various types of tissue, including epithelial tissue, connective tissue (e.g., bone, cartilage, adipose tissue, blood, lymphoid tissue), muscle tissue, and/or nervous system tissue, although alternative samples are contemplated. In aspects, tissue 152 may be configured to adhere to gel 154. Generally, cassette 150 is composed of a durable polymer and/or plastic, although alternative materials are contemplated. While shown as a circular-shaped disc, various configuration for cassette 150 are contemplated (e.g., square plate). In aspects, cassette 150 includes drainage holes (not shown) configured to drain stain 912a and/or rinse 914a.

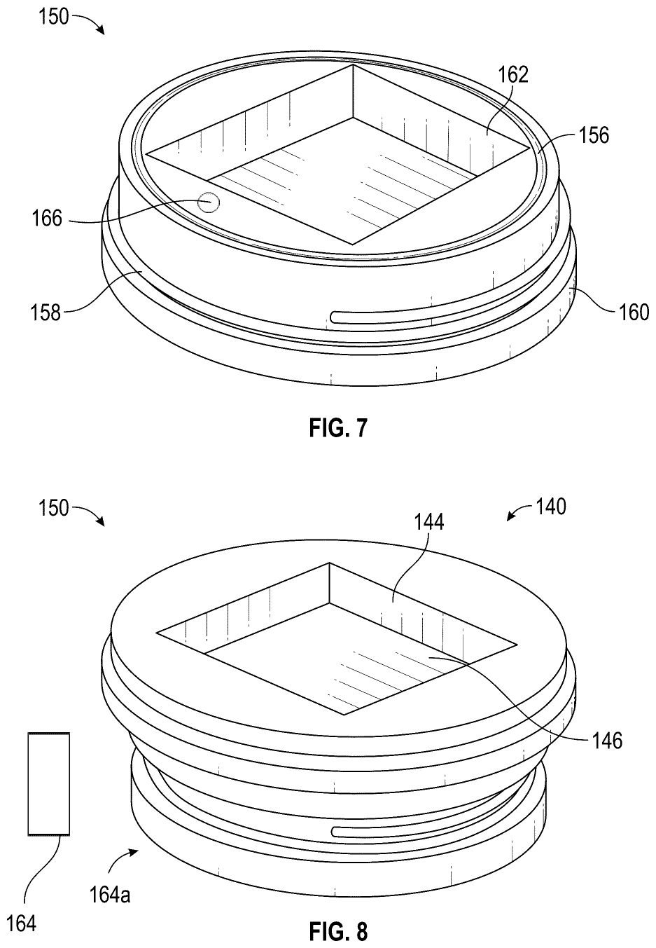

Gel 154 may be an adhesive gel material, which is configured to allow for compression of tissue 152 while maintaining stability thereof, e.g., minimizing movement or deformation of tissue 152 during imaging, preventing dislodging of tissue 152 from gel 154, and/or and providing optical clarity for visualization. For example, gel 154 may maintain tissue 152 therein during rinsing and/or when tissue staining system 100 is oriented upside-down. Generally, gel 154 contains 3% agarose, which may be crosslinked with a polyacrylate to increase adhesion with tissue 152. Gel 154 and/or tissue 152 may be housed within recess 562 of cassette 150 (FIG. 7).

In aspects, additional and/or alternative gels that promote adhesion are contemplated, including glycerol gel, mounting mediums with gelatin, polyvinyl alcohol (PVA) gel, superglue, and/or embedding mediums with methylcellulose. For example, gel 154 may include passive/inactive ingredients for providing increased stiffing and/or cold-foaming abilities, which permit tissue 152 to be gently compressed into window 146 (disclosed below) and/or flattened therein for proper in-plane imaging (e.g., along a specific plane or slice of tissue 152) without inducing excessive force that may damage tissue 152. In aspects, gel 154 may include various active ingredients that assist with primary pathology imaging of tissue 152. For example, gel 154 may include contrasts ingredients such as immunohistochemical stains to enhance optical imaging for pathological analysis purposes.

In aspects, gel 154 may include various active ingredients for aiding with downstream processes after the primary pathology imaging of tissue 152. For example, gel 154 may include formaldehyde to aid in chemical fixation, e.g., chemically fixing tissue 152 therein, which allows compatibility with pathology processes complementary to confocal pathology (e.g., standard formalin-fixed, paraffin-embedded pathology). In another example, gel 154 may include dimethyl sulfoxide to aid in cryopreservation of tissue 152, e.g., by protecting living cells.

A cover 140 may be configured to compress tissue 152 inside cassette 150 (FIG. 8), thereby allowing tissue 152 to be properly imaged. Cover 140 may include an upper surface 142a, a lower surface 142b, a first outer perimeter 142c, a second outer perimeter 142d, recess 144, and/or window 146. Generally, window 146 is composed of a glass plate (e.g., a viewing window) although alternative durable materials (e.g., plastic), shapes (e.g., circular) and/or suitable sizes are contemplated. inserted through recess 144, such that window 146 is flush with lower surface 142b. Window 146 may be translucent to permit imaging of tissue 152 therein, and window 146 may between approximately 1-10 cm in width and/or 1-10 cm in length (e.g., may be approximately 5 cm by 5 cm).

Grip 160 is designed to promote enhanced traction and/or stability while tissue staining system 100 is in use, e.g., to prevent dropping, slippage, and/or unintended movement of the components. Grip 160 may include various materials that promote anti-slippage, such as rubber, silicone, polyurethane, textured paints, vinyl, adhesive tapes, and/or metal gratings. In aspects, grip 160 may include a textured and/or contoured surface, ribbed grips, finger grooves/indentations, palm swells, adjustable straps, bands, and/or anti-slip coatings.

In aspects, cassette 150 may include a thermally conductive material 164a, which is configured to interact with a cooling system 164 (e.g., a cooler) to maintain a suitable temperature of tissue 152 during pathologic imaging (e.g., 4 degrees Celsius), such as when cassette 150 is under light illumination. Cooling system 164 may be thermally conductive system including fans, liquids, and/or electrical components used to enhance heat dissipation from cassette 150. For example, cooling system 164 may be a thermoelectric cooler such as a Peltier cooler. In aspects, cooler 164 may be pre-programmed and/or controllable by a user to maintain a preset temperature. Thermally conductive material 164a may be a thermal pad or any other material and/or thermal coupling mechanism used to enhance a cooling effect of cooling system 164.

In use, cover 140 is attached to cassette 150 using friction-fit and/or gasket 156 (e.g., an O-ring) to reduce leakage of substances therefrom. In doing so, lower surface 142b of cover 140 compresses upper surface 150a of cassette 150. Further, first outer perimeter 142c is approximately the same size or slightly larger than first outer perimeter 152c, forming a tight seal. Generally, second outer perimeter 142d is larger than first outer perimeter 142c, and second outer perimeter 142d is larger than first outer perimeter 142c. In aspects, second outer perimeter 142d and second outer perimeter 152d may be the same size, e.g., approximately 5 cm in diameter. In aspects, a base of cassette 150 may include a lock and/or dovetail groove to hold gasket 156 into place.

During compression of cover 140 against cassette 150, tissue 152 is compressed into gel 154. Generally, cover is placed on a surface and cassette 150 is oriented upside down, so that gel 154 is pressed into viewing window 146 of cover 140. Grip 160 may be held during compression to ensure better control of tissue staining system 100. Window 146 may flush with lower surface 142b of cover 140 and/or upper surface 150a of cassette 150, thereby permitting a microscope 170 to scan the tissue 152 in cassette 150 from a distance while avoiding contact therewith. For example, window 146 may permit microscope lens 172 to scan tissue 152 from between approximately 180-220 um away without contacting any portion of cassette 150. Once compression is complete, cassette 150 may be placed into microscope 170 for imaging. In aspects, cover 140 and/or cassette 150 may include magnets 166 embedded therein, which ensure proper compression is applied to the tissue 152. Magnets 166 may be placed a variety of arrangements, such as along each edge and/or corner of cover 140 and/or cassette 150, in one or more rows.

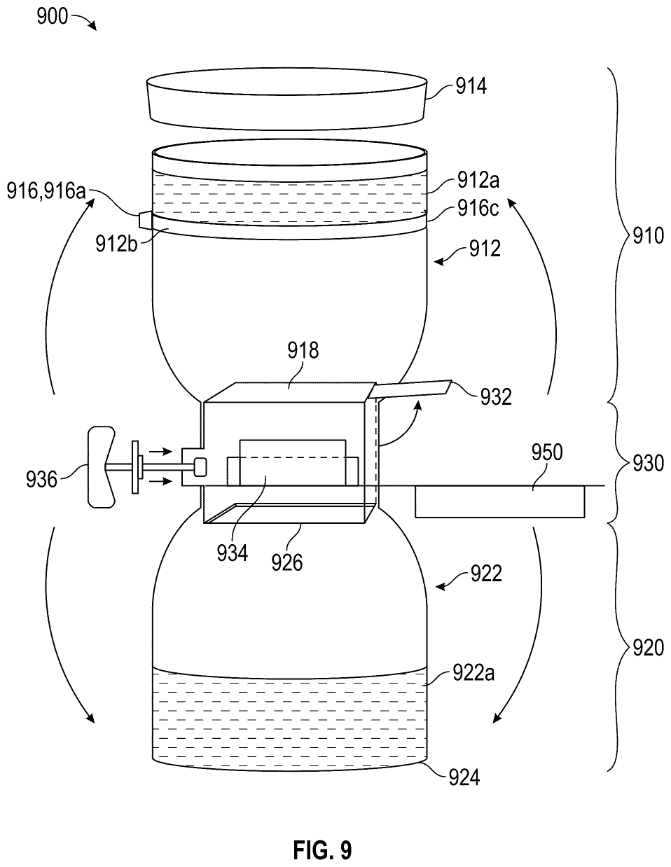

Now referring to FIGS. 9-13, a tissue staining system 900 is shown according to aspects of the present disclosure. Tissue staining system 900 includes an upper housing 910, (e.g., a first liquid delivery system), a lower housing 920, (e.g., second liquid delivery system), and a central housing 930 (e.g., a fixation and/or lever system). Portions of tissue staining system 900 may be manually attached to and/or separated via threading and/or a screw (not shown). In aspects, tissue staining system 900 may be a fully disposable system. As with tissue staining system 100, gravitational forces may be utilized for transporting fluids for staining and/or rinsing biological samples. For example, tissue staining system 900 may be turned upside-down to let a liquid drain back into a reservoir and/or perform a rinsing function. Tissue staining system 900 is similar in aspects to tissue staining system 100, and for brevity, primarily the differences will be discussed.

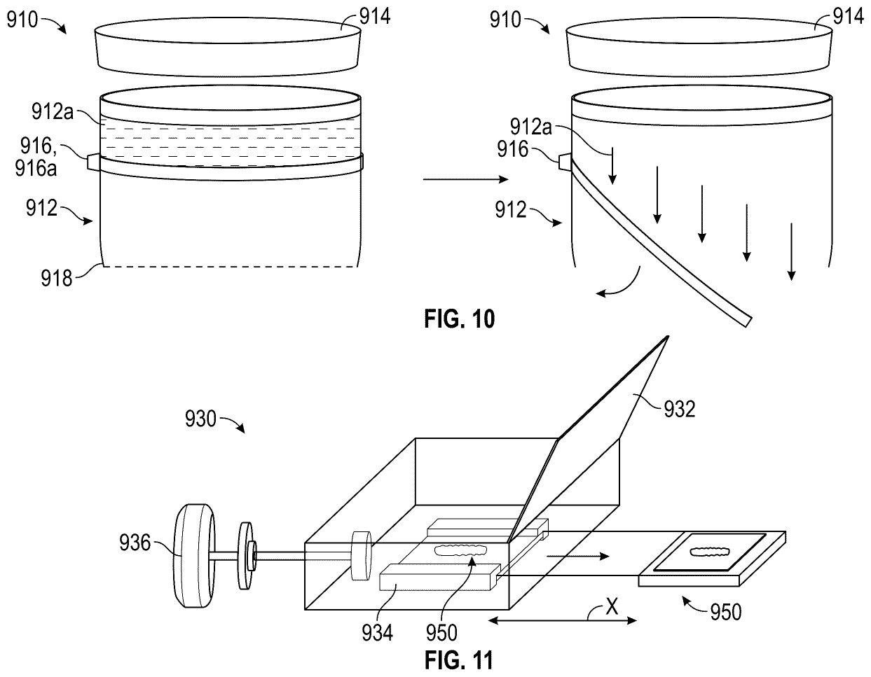

Referring to FIG. 10, upper housing 910 includes a reservoir 912, a lid 914, valve assembly 916, and/or straining grate 918. Reservoir 912 is configured to retain and/or deliver a substance (e.g., a liquid or gas), such as stain 912a, which may be used to label (e.g., stain) a portion of a biological sample, e.g., tissue 952, including specific structures and/or molecules thereof. For example, stain 912a may include acridine orange. In aspects, reservoir 912 may be pre-filled before assembly. Lid 914 may be placed on reservoir 912 to form a liquid-tight seal. In aspects, lid 914 may include a gasket, e.g., an O-ring (not shown) to further reduce leakage of stain 912a from reservoir 912. Valve assembly 916 controls the flow of stain 912a through upper housing 910 into central housing 930. Straining grate 918 is configured to further regulate the flow of fluid therethrough, thereby controlling a rate at which stain 912a can be released onto the tissue 952.

Valve assembly 916 may be utilized to prevent potentially toxic substances, e.g., stain 912a, from mixing with other components of the tissue staining system 900. Valve assembly 916 generally includes include an actuator 916a, a lever 916b, and/or a lock 916c. When actuator 916a is actuated, lever 916b is released from lock 916c, permitting stain 912a to flow into central housing 930. Actuator 916a may be actuated using a clicking, pressing, and/or a pulling motion, although other methods are contemplated. For example, actuator 916a may be a spring-loaded button. Lock 916c may be a latch, magnet, and/or spring.

In aspects, rather than directly receiving stain 912a, upper portion 910 may receive a stain packet (not shown). Upper portion 910 may include spikes (not shown) configured to pierce the stain packet, releasing the stain 912a into central housing 930. The spikes may be included with and/or in replace of the valve assembly 916.

Lower housing 920 includes a reservoir 922, a lid 924, and/or straining grate 926. Reservoir 922 is configured to retain and/or deliver a substance (e.g., a liquid or gas), such as rinse 922a, which may be used to wash the tissue 952 after labeling and/or staining thereof. For example, rinse 922a may contain Phosphate-Buffered saline (PBS). In aspects, reservoir 922 may be pre-filled before assembly. Lid 924 may be placed on reservoir 922 to form a liquid-tight seal. In aspects, lid 924 may include a gasket, e.g., an O-ring (not shown) to further reduce leakage of rinse 922a from reservoir 922. Straining grate 926 is configured to modulate the flow of rinse 922a. In aspects, reservoir 922 may also include a valve assembly (not shown).

The flow of liquid, (e.g., stain 912a and rinse 922a) through straining grates 918, 926 may be regulated through the number and/or diameter of holes within straining grates 918, 926. For example, calculating the velocity of fluid flow through each individual hole of straining grates 918, 926 may determine the number of holes required for proper exposure times of stain 912a and rinse 922a on tissue 952. To calculate the speed of liquid flow through a singular hole, Bernoulli's Equation can be utilized:

$${P}_{1} + \frac{1}{2} {pv}_{1}^{2} + {pgh}_{1} = {P}_{2} + \frac{1}{2} {pv}_{2}^{2} + {pgh}_{2}$$

Here, p is equal to the fluid density, g is the acceleration due to gravity, P₁ represents the pressure at elevation 1, v₁ is the velocity at elevation 1, h₁ is the height at elevation 1, P₂ represents the pressure at elevation 2, v₂ is the velocity at elevation 2, h₂ is the height of elevation 2. It can be assumed that the pressure within the device would be equal to that of atmospheric pressure, and therefore P₁ will be equal to P₂. It can also be assumed that the area of the top reservoir 912a will be much greater than the area of the hole in which the fluid (e.g., stain 912a) will flow. Thus, the speed at which the fluid flows at v₁ may be almost negligible compared to the speed at which the fluid flows out of the hole. With these assumptions, the equation may be simplified to:

$${v}_{2} = \sqrt{2 {gh}_{2}}$$

The result of these substitutions is equal to Torricelli's theorem, which relates the exit velocity of a fluid from a hole in straining grate 918, 926 in reservoir 912, 922, to the height of the fluid above the hole thereof. Further, accounting for the decrease in exit velocity as the height in the reservoir 912, 922 decreases, may ensure tissue 952 receives the proper exposure to the stain 912a and rinse 922a.

A surface tension of the stain 912a and/or rinse 922a within tissue staining system 900 may also be considered. For example, sloping the entry to the hole of straining grates 918, 926, chamfering the inside of the holes, and/or smoothing the material may ensure that a liquid height is sufficient to provide the requisite pressure to move the liquid through the holes.

In order to determine the diameter of each hole, the Fluid Volume Flow, or Flux, may be calculated. The flux will be the volume of the fluid that leaves the hole using units consistent with volumetric flow rates. This calculation can be found by multiplying the velocity of the liquid flow by the cross-sectional area of the hole, shown as:

$$Q = Av$$

The force required to push the cover 940 against cassette 950 and/or tissue 952 may also be calculated for optimal compression, viewing and/or imaging (e.g., may determine the force required to accelerate a stopped object to a given velocity). Newton's Second Law of motion (shown below) may be referenced, with F equal to force, m equal to mass, and a equal to acceleration of the object. Since the initial velocity is known, and an optimal end velocity can be tested for, acceleration can be set equal to the change in velocity over the change in time. In order to utilize this equation, the mass of both the cover 940 and the largest possible tissue 952 may be determined prior to completion:

$$F = ma$$

$$F = m \times \frac{Δ v}{Δ t}$$

It will be understood that the above calculations may also apply to tissue staining system 100. For example, the speed of liquid flow through hole(s) in a straining grate in tissue reservoirs 112, 114 may be applicable. In another example, the calculations may be applicable to holes within mesh guard 132.

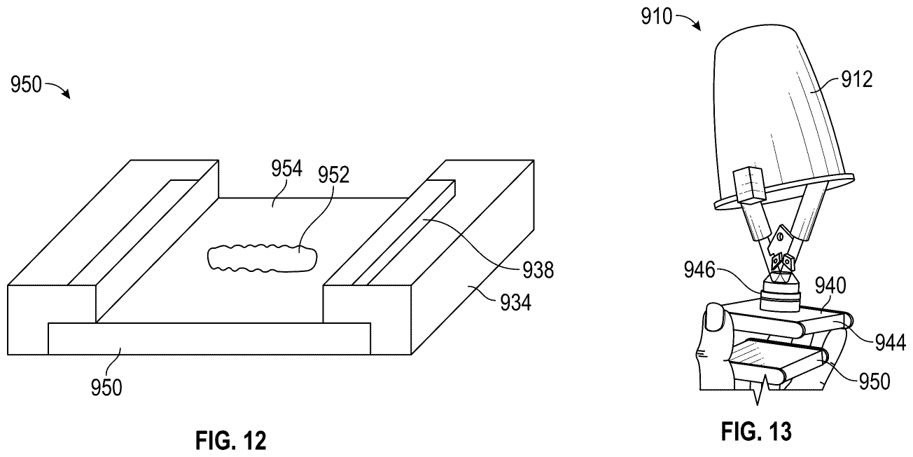

Now referring to FIGS. 11 and 12, upper housing 910 and lower housing 920 may be connected directly, with central housing 930 formed therebetween configured to hold cassette 950. Generally, upper housing 910 and lower housing 920 may each be connected to central housing 930 via threading, although alternative attachment methods are contemplated. In aspects, central housing 930 includes a door 932, a guard rails 934, and/or an actuator 936. Door 932 may be configured to pivot open and closed, permitting entry and/or exit of a cassette therethrough. Guard rails 934 are configured to secure cassette 950 therein to preserve a position and/or orientation of tissue 952. For example, the guard rails 934 may permit controlled movement of cassette 950 along a single axis, e.g., an axis X defined by a length of guard rails 934. In aspects, guard rails 934 may include a lock 938 to further hold cassette 950 in place (FIG. 12). It is contemplated that, rather than cassette 950, guard rails 934 may hold a platform (e.g., cover) in place, which is pushed by actuator 936 to release tissue 952 onto a central portion of cassette 950.

Actuator 936 may be a push handle, which is actuated by a pressing motion, although alternative methods (e.g., screwing, pulling, clicking) are contemplated. For example, actuator 936 may be a spring-loaded handle. When actuated, actuator 936 is configured to advance a cassette 950 through central housing 930. In doing so, cassette 950 pushes against door 932, which pivots open to permit cassette 950 to exit central housing 930 therethrough.

Similar to cassette 150, cassette 950 includes a gel configured to house a tissue 952 therein. Generally, gel 954 contains 3% agarose, which may be crosslinked with a polyacrylate to increase adhesion with tissue 952. In aspects, additional and/or alternative gels that promote adhesion are contemplated, including glycerol gel, mounting mediums with gelatin, polyvinyl alcohol (PVA) gel, superglue, and/or embedding mediums with methylcellulose. While housed within central housing 930, cassette 950 is generally retained by guard rails 934 (FIG. 12). In aspects, cassette 950 may include a grip (not shown) designed to promote enhanced traction and/or stability while tissue staining system 900 is in use.

Now referring to FIG. 13, a cover 940 (e.g., a platform) may compressed against cassette 950 after staining is complete. Cover 940 may include window (e.g., a viewing window, not shown). In aspects, cover 940 may be configured to attach to upper housing 910 via a double-sided screw 946. Cover 940 may be configured to compress tissue 952 into gel 954 for imaging. Once cover 940 is sealed onto cassette 950, cover 940 may be mechanically ejected from upper housing 910 using an actuator 984. In aspects, tissue 952 may already be compressed into gel 954 prior to any compression by cover 940. Actuator 984 may be any device configured to eject the platform 982, such as a spring-loaded device, pneumatic cylinder, hydraulic cylinder, rotary ejector, and/or gravity-driven device. In aspects, actuator 984 may apply controlled and/or evenly distributed force and/or include a stopper (not shown) to minimize compression of tissue 952 and/or gel 954.

Generally, tissue staining system 100 and/or tissue staining system 900 may be manufactured from a clear, polypropylene (PP) material with an injection molding technique, which can improve the usability of the design and/or provide smoother user interaction due to the improved tolerances and ability to view tissue 152, 952 during staining. Further, such PP material meets the chemical stability of the tissue staining system 100, 900 and has the ability to be autoclaved if desired to transition to a reusable design. However, alternative materials may be used based on the specific application and/or chemicals used. For example, various metals, polyethylene (PE), polyvinyl chloride (PVC), polystyrene (PS), polyethylene terephthalate (PET), and/or acrylonitrile butadiene styrene (ABS) are contemplated. In aspects, valve 120, valve assembly 916, may be manufactured from a polyvinylchloride (PVC) to provide stability while decreasing the overall cost of manufacturing, although various metals including steel, cast iron, and/or aluminum are contemplated. In aspects, portions of tissue staining system 100 and/or tissue staining system 900 may be manufactured using three-dimensional (3D) printing techniques.

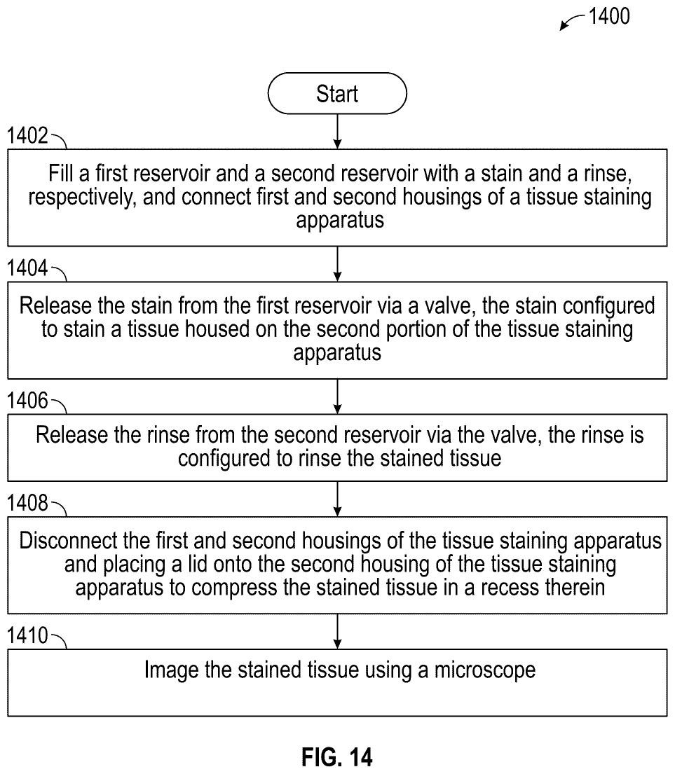

FIG. 14 shows a method 1400 for an exemplary use of the tissue staining system 100 according to aspects of the present disclosure. Although the steps of method 1400 of FIG. 14 are shown in a particular order, the steps need not all be performed in the specified order, and certain steps can be performed in another order. In various aspects, the method 1400 of FIG. 14 may be performed all or in part by components of tissue staining system 900. These and other variations are contemplated to be within the scope of the present disclosure.

Initially, at step 1402, reservoirs 112, 114 are filled with the substances required for staining and/or rinsing tissue 152, and upper portion 110 may be connected to cassette 150. A user may first ensure that valve 120 is closed, and/or close valve 120, in order to prevent release of the substance(s) while reservoirs 112, 114 are filled. The user may ensure that valve 120 is closed by observing a state and/or position of turning knobs 122. For example, turning knobs 122 may be switched 90 degrees to the flow, signaling a closed position. In aspects where conduits 124a-c and/or valve 120 are made with a translucent material, it may be possible to verify a state and/or position of valve 120 itself.

Thereafter, the user may fill conduits 124a, 124b with the required substances. For example, reservoir 112 may be filled with a stain 112a, such as acridine orange, and reservoir 114 may be filled with a rinse 114a, such as a saline rinse. In aspects, reservoirs 112, 114 may include various fill lines to indicate that a sufficient amount of the required substance is present, which may be based on the volume and/or type of tissue 152 to be stained. In aspects, reservoirs 112, 114 may come pre-filled with a stain 112a and/or rinse 114a, eliminating the need for filling. Once filled, reservoirs 112, 114 may be secured to conduits 124a, 124b. For example, reservoir 112 may be screwed onto conduit 124a via threading, and reservoir 114 may likewise be screwed onto conduit 124b via threading. In aspects, reservoirs 112, 114 may include a snap and/or locks to enhance attachment to conduits 124a, 124b.

Next, at step 1404, the user may proceed to stain tissue 152. Generally, tissue 152 is pre-placed onto gel 154 with a margin side facing upwards. The user will open the left portion of valve 120 via the left turning knob 122, thereby releasing the stain 112a through conduits 124a, 124c, through funnel 130, and onto cassette 150 housing tissue 152. The stain 112a may be allowed to soak on tissue 152 for a predetermined amount of time, such as between approximately 10-50 seconds (e.g., 30 seconds), which will allow the stain 112a to saturate tissue 152 and/or permeate a layer of tissue 152 as desired.

After staining is complete, the tissue staining system 100 may be inverted to allow any remaining stain 112a to drain back into reservoir 112. The tissue staining system 100 may be inverted for a predetermined amount of time, e.g., 30 seconds, to ensure that no excess of stain 112a remains in cassette 150. In aspects where cassette 150 is made from a translucent material, it may be possible for the user to verify that all excess of stain 112a is removed without checking the state of reservoir 112. Thereafter, tissue staining system 100 may be oriented right-side up again, and the left portion of valve 120 may be closed by turning the left turning knob 122.

Next, at step 1406, the user may rinse the tissue 152. The user will open the right portion of valve 120 via the right turning knob 122, thereby releasing the rinse 114a through conduits 124b, 124c, through funnel 130, and onto cassette 150 housing tissue 152. The rinse 114a may be allowed to soak on tissue 152 for a predetermined amount of time, such as between approximately 1-20 seconds (e.g., 10 seconds), which can remove any remaining excess stain 112a from tissue 152 and/or cassette 150 generally.

After rinsing is complete, the tissue staining system 100 may be inverted again to allow any remaining rinse 114a to drain back into reservoir 114. The tissue staining system 100 may be inverted for a predetermined amount of time, e.g., 30 seconds, to ensure that no excess rinse 114a remains in cassette 150. In aspects where cassette 150 is made from a translucent material, it may be possible for the user to verify that all excess rinse 114a is removed without checking the state of reservoir 114. Thereafter, tissue staining system 100 may be oriented right-side up again, and the right portion of valve 120 may be closed by turning the right turning knob 122.

Next, at step 1408, the user may prepare the cassette 150 for imaging. Here, the user will disconnect the cassette 150 from the upper portion 110 of the tissue staining system 100, exposing the cassette 150. The cover 140 may then be compressed onto to the respective cassette 150, resulting in the final cassette 150, which is ready for imaging. In aspects, cover 140 and cassette 150 may be attached using a friction fit and/or gasket 156 (e.g., an O-ring), which may ensure a liquid tight seal to reduce leakage.

Next, at step 1410, the user may complete imaging of the tissue 152 within the cassette 150 using microscope lens 172 of microscope 170. Due to the position of window 146 (e.g., flush with lid), microscope lens 172 may scan the cassette 150 from at least 200 um away without contacting any part of the cassette, producing highly accurate imaging results.

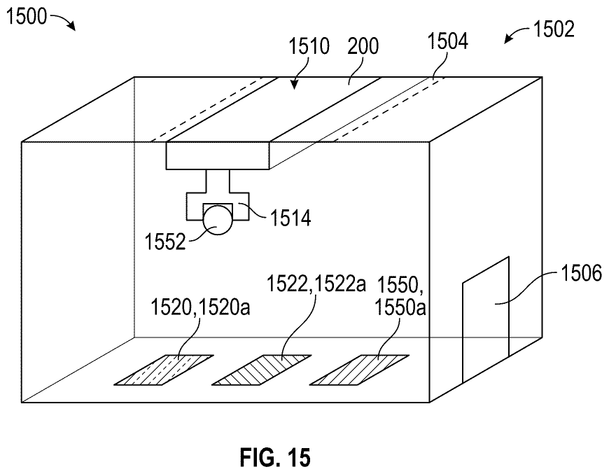

Now referring to FIGS. 15-18, a tissue staining system 1500 is shown. Tissue staining system 1500 includes a housing 1502, which includes doors 1504, 1506, arm 1510, reservoirs 1520, 1522, and/or cassette 1550. Tissue staining system 1500 is an automated or semi-automated system configured to stain a tissue within a contained housing. Tissue staining system 1500 is similar in aspects to tissue staining systems 100 and 900, and for brevity, primarily the differences will be discussed.

Doors 1504, 1506 are configured to permit access into a portion of housing 1502, for example, for cleaning of tissue staining system 1500 and/or troubleshooting. Door 1504 is configured to permit entry into housing 1502 from a top portion thereof, such as for loading arm 1510 into housing 1502. Door 1706 is configured to permit entry into housing 1702 from a side portion thereof, such as for retrieving cassette 1550. Doors 1504, 1506 may be manually opened/closed and/or automatically sealed during the tissue staining process to prevent contamination or exposure to toxic chemicals.

Reservoirs 1520, 1522, are each configured to hold a substance. Reservoirs 1520, 1522 are generally trays but may be containers, soaked pads, bowls, and/or other compatible devices configured to retain a substance. Reservoir 1520 may be configured retain and/or deliver a substance (e.g., a liquid or gas), such as stain 1520a, which may be used to label (e.g., stain) a portion of a biological sample, e.g., tissue 1552, including specific structures and/or molecules thereof. For example, stain 1520a may include acridine orange. Reservoir 1522 may be configured to retain and/or deliver a substance (e.g., a liquid or gas), such as rinse 1522a, which may be used to wash the tissue 1552 after labeling and/or staining thereof. For example, rinse 1522a may contain Phosphate-Buffered saline (PBS).

Cassette 1550 is similar in aspects to cassettes 150, 950, and includes a gel 1550a configured to house tissue 1552 therein. Generally, gel 1550a contains 3% agarose, which may be crosslinked with a polyacrylate to increase adhesion with tissue 1552. In aspects, additional and/or alternative gels that promote adhesion are contemplated, including glycerol gel, mounting mediums with gelatin, polyvinyl alcohol (PVA) gel, superglue, and/or embedding mediums with methylcellulose.

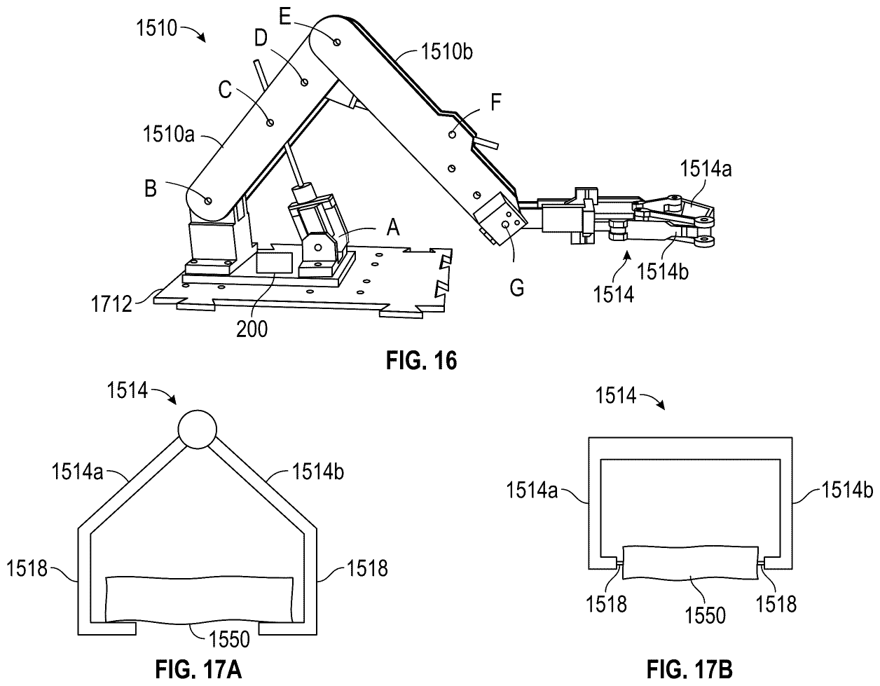

With further reference to FIG. 16, arm 1510 includes links 1510a, 1510b, base 1512, end effector 1514, and/or controller 200. Arm 1510 is generally an articulating robotic arm, which is configured operate through commands generated via controller 200. For example, controller may generate specific commands to determine x and y directions of movement of arm 1510. In aspects, arm 1510 may be fully automated and/or have a manual mode of operation. Base 1512 provides the foundation and support for the entire robotic arm 1510, permitting both mobility and flexibility in positioning (e.g., allowing both horizontal and vertical rotation of the robotic arm 1510). Arm 1712 may include multiple joints A-G configured to move links 1510a, 1510b, which generate multiple degrees of freedom (e.g., 7 degrees of freedom). For example, joints A-G may control a swing, rotation, and/or bending motion of the robotic arm 1510. It will be understood that while seven joints A-G are shown, any number of joints and/or configurations thereof are contemplated.

Joints A-G may include actuators (not shown) configured to articulate joints A-G, such as electric motors, pneumatic cylinders, and/or hydraulic actuators. In aspects, joints A-G may include sensors (not shown) configured to provide feedback to controller 200. The sensors may include encoders for measuring joint angles, force/torque sensors for detecting interaction forces, and/or vision systems for object detection and localization. In aspects, arm 1710 and/or the actuators may include a power source such as electrical power from batteries or a power grid, hydraulic power, and/or pneumatic power.

End effector 1514 is generally a gripper, which is configured grasp, hold, transport, and/or manipulate tissue 1552, thereby eliminating the need for forceps and guaranteeing consistent, accurate imaging on the margin side of tissue 1552. End effector 1514 generally has two jaws 1514a, 1514b, although any number thereof are contemplated.

With further reference to FIG. 17A, end effector 1514 may be a friction gripper, which relies on the force of the gripper (e.g., surface tension between tissue 1552 and end effector 1514) to hold tissue 1552. In doing so, when jaws 1514a, 1514b close around the tissue 1552, the friction between the surfaces creates a secure hold. The friction gripper may have jaws with textured surfaces, such as rubber pads or serrated edges, to increase friction and improve grip. For example, the friction gripper may include pins 1518 configured to maintain an orientation of the tissue 1552 without damaging the margin side thereof.

With further reference to FIG. 17B, end effector 1514 may be an encompassing gripper, which cradles the tissue 1552. In doing so, jaws 1514a, 1514b surround the tissue 1552, rather than gripping the tissue 1552 at sides thereof, which provides added stability. The encompassing gripper may have flexible fingers, inflatable bladders, and/or other adaptive features to conform to the shape of the tissue 1552 and/or provide a secure hold from multiple directions. For example, similar to above, the encompassing gripper may include pins 1518.

The weight of tissue 1552 may be considered to determine the type of end effector 1514 used. For example, the weight of tissue 1552 may determine the grip force required by end effector 1514, which can be modeled as:

$$Grip Force = Part Weight \times ( 1 + Part Gs ) \times Jaw Style Factor$$

Part Weight is the weight of tissue 1552, Part Gs represents gravity, and Jaw Style Factor represents the effect of friction grip versus encompassing grip. In aspects, a friction gripper may require up to 4 times more force than an encompassing gripper. Further, arm 1510 may have an acceleration of 3 to 4 times the gravitational acceleration.

The torque of the end effector 1514 may also be studied, as shown:

$$Grip Torque = Grip Force \times Jaw Length$$

Jaw Length is measured by the face of the end effector 1514 to the center of gravity of the tissue 1552. For example, grip torque of end effector 1514 may increase as a length of jaws 1514a, 1514b increases. The torque of the tissue 1552 may be considered for determining the amount of power tissue 1522 has on the grip:

$$Part Torque = Jaw Length \times Part Weight \times Acceleration$$

To ensure a proper grip and/or prevent damage to the tissue, the strength of the average tissue specimen may be determined. In aspects, the tissue strength may be calculated via tensile and compressive indentation testing to calculate Young's Elastic Modulus. First, the stress and strain may be calculated:

$$Stress ( MPa ) = \frac{force ( N )}{cross - sectional area of sample ( {mm}^{2} ) \times compression} \\ Strain ( \% ) = \frac{{length}_{New} ( mm ) - {length}_{Original} ( mm )}{{length}_{Original} ( mm )}$$

The stress and strain calculations can then be used to generate a stress-strain curve, in which the slope of the linear fit will correspond to the Young's Modulus.

The power capacity may also be considered when selecting a power supply:

$$P = V \times I$$

P is the power in watts, V is the voltage in volts, and I is the current in amperes. The input voltage may range from 100 V to 240 V at frequencies between 50 Hz to 60 Hz. This range may allow the tissue staining system 1500 to be applicable to power supplies globally. In aspects, the arm 1510 be tested for the peak current required to ensure functioning at the proper voltage.

In use, each reservoir 1520, 1522, is filled with the desired substance and placed into housing 1502, e.g., through opened door 1504. For example, reservoir 1520 may be filled with stain 1520a, and reservoir 1522 may be filled with rinse 1522a. In aspects, reservoirs 1520, 1522 may be pre-filled or pre-soaked prior to placement. Next, tissue 1552 is grasped by end effector 1514 and prepared for staining. Arm 1510 may then be configured to move in the direction of reservoir 1520 to begin staining. While firmly grasping tissue 1552, arm 1510 will lower tissue 1552 into reservoir 1520, fully submerging tissue 1552 into stain 1520a for a predetermined period of time (e.g., 20-30 seconds). The process may be repeated for reservoir 1522 to rinse tissue 1552 using rinse 1522a. While rising, end effector 1514 may move up and down and/or side-to-side to stir rinse 1522a, which may ensure all stain 1520a is removed from tissue 1552. After rinsing, tissue 1552 may be placed by arm 1510 onto cassette 1550. Thereafter, a lid (not shown) may be placed onto cassette 1550, compressing tissue 1552 therein for imaging. Finally, cassette 1550 may be removed from housing 1502, via door 1504 or door 1506.

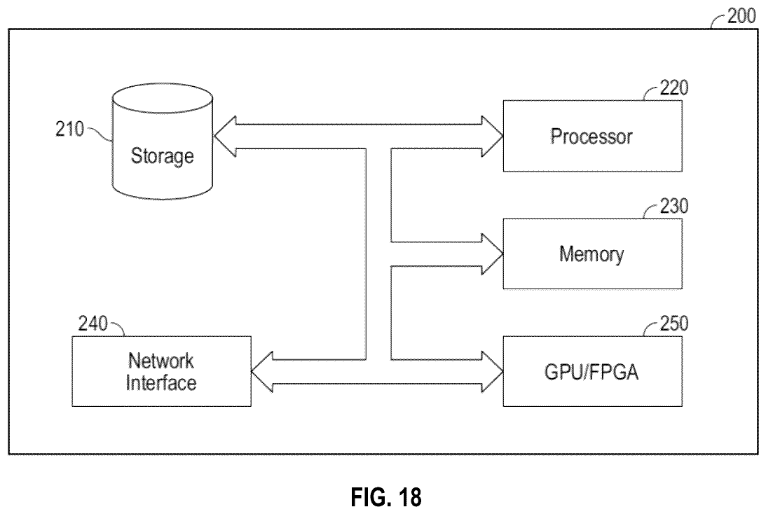

Now referring now to FIG. 18, exemplary components of the controller 200 are shown. The controller 200 generally includes a storage or database 210, one or more processors 220, at least one memory 230, and a network interface 240. In aspects, the controller 200 may include a graphical processing unit (GPU) 250, which may be used for processing machine learning network models.

The database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In aspects, data may be stored on the controller 200, including, for example, tissue orientation, grip strength, motion coordinates, and/or other data. The data can be stored in the database 210 and sent via the system bus to the processor 220. The database 210 may store information in a manner that satisfies information security standards and/or government regulations, such as Systems and Organization Controls (e.g., SOC 2), General Data Protection Regulation (GDPR), and/or International Organization for Standardization (ISO) standards.

The processor 220 executes various processes based on instructions that can be stored in the at least one memory 230 and utilizing the data from the database 210. For example, a request from a user device (e.g., a mobile device or a client computer), can be communicated to the controller 200 through the network interface 240. The illustration of FIG. 2 is exemplary, and persons skilled in the art will understand that other components may exist in controller 200. Such other components are not illustrated for clarity of illustration.

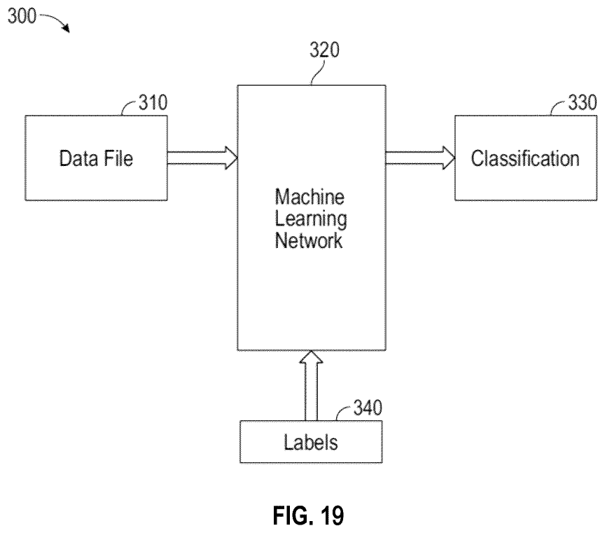

With reference to FIG. 19, a block diagram for a machine learning network 320 for classifying data in accordance with some aspects of the disclosure is shown. In some systems, a machine learning network 320 may include, for example, a convolutional neural network (CNN), a regression and/or a recurrent neural network. A deep learning neural network includes multiple hidden layers. As explained in more detail below, the machine learning network 320 may leverage one or more classification models 330 (e.g., CNNs, decision trees, a regression, Naive Bayes, k-nearest neighbor) to classify data. In aspects, the classification model 300 may use a data file 310 and labels 340 for classification. The machine learning network 320 may be executed on the controller 200 (FIG. 18). Persons of ordinary skill in the art will understand the machine learning network 320 and how to implement it.

In machine learning, a CNN is a class of artificial neural network (ANN). The convolutional aspect of a CNN relates to applying matrix processing operations to localized portions of data, and the results of those operations (which can involve dozens of different parallel and serial calculations) are sets of many features that are delivered to the next layer. A CNN typically includes convolution layers, activation function layers, deconvolution layers (e.g., in segmentation networks), and/or pooling (typically max pooling) layers to reduce dimensionality without losing too many features. Additional information may be included in the operations that generate these features. Providing unique information, which yields features that give the neural networks information, can be used to provide an aggregate way to differentiate between different data input to the neural networks.

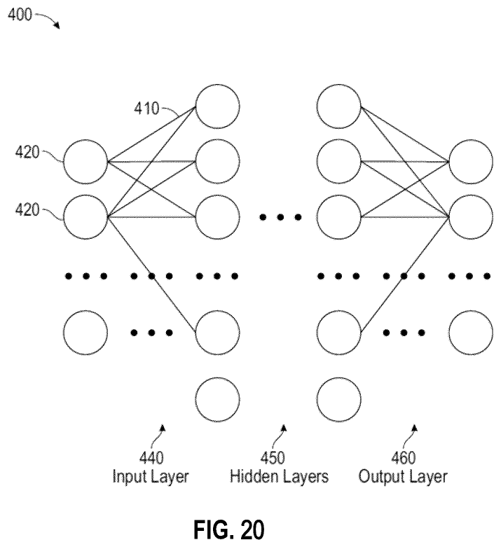

Referring to FIG. 20, generally, a machine learning network 320 (e.g., a convolutional deep learning neural network) includes at least one input layer 440, a plurality of hidden layers 450, and at least one output layer 460. The input layer 440, the plurality of hidden layers 450, and the output layer 460 all include neurons 420 (e.g., nodes). The neurons 420 between the various layers are interconnected via weights 410. Each neuron 420 in the machine learning network 320 computes an output value by applying a specific function to the input values coming from the previous layer. The function that is applied to the input values is determined by a vector of weights 410 and a bias. Learning, in the deep learning neural network, progresses by making iterative adjustments to these biases and weights. The vector of weights 410 and the bias are called filters (e.g., kernels) and represent particular features of the input (e.g., a particular shape). The machine learning network 320 may output logits. Although CNNs are used as an example, other machine learning classifiers are contemplated.

The machine learning network 320 may be trained based on labeling training data to optimize weights. For example, samples of feature data may be taken and labeled using other feature data. In some methods in accordance with this disclosure, the training may include supervised learning or semi-supervised. Persons of ordinary skill in the art will understand training the machine learning network 320 and how to implement it.

Now referring to FIGS. 19 and 20, tissue staining systems 100, 900, 1500 may utilize direct-to-digital confocal pathology, which is a slide-free imaging method performed on whole tissue without microscopic resolution. Thereafter, machine learning trained on a variety of diagnostic imaging may be employed to identify structures in the imagine, e.g., in the tissue pictured, e.g., using machine learning network 320 (FIGS. 19 and 20). Machine learning network 320 may be incorporated into a controller of an imaging device (not shown) and/or a controller included with any of tissue staining systems 100, 900, 1500.

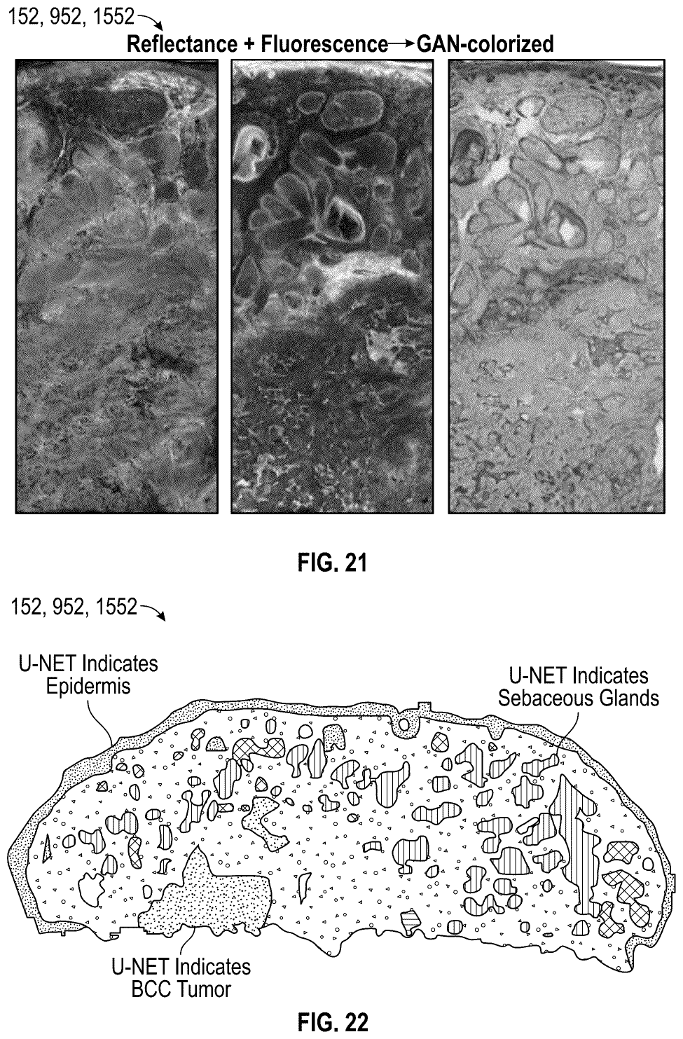

With reference to FIG. 21, a generalized adversarial network (GAN) may be used to transform confocal images of tissue 152, 952, 1552 into a colorized style, which can be useful for visualizing and analyzing confocal microscopy data. Such colorized images may be highly accurate and mimic the appearance of standard histopathology. To do so, the GAN may be trained to learn the mapping between grayscale confocal images and colorized versions of the same confocal images. First, a dataset of grayscale confocal images along with their corresponding colorized versions is gathered. The colorized images can either be manually colorized by experts or obtained from existing datasets. The images may be preprocessed as needed, which may include resizing, normalization, and/or augmentation techniques to increase the diversity and robustness of the dataset. Next, the GAN may be trained with this preprocessed dataset.

After training, the trained GAN may be validated on a separate dataset to assess performance and generalization ability, which can ensure that the GAN is producing high-quality colorized images that are faithful to the original grayscale confocal images. Once the GAN has been trained and validated, it can be used to colorize new grayscale confocal images. The trained generator network takes grayscale confocal images as input and outputs colorized versions.

Further, F with reference to FIG. 22, deep learning techniques may be used to identify diseases within the colorized confocal images of tissue 152, 952, 1552, enabling rapid and accurate analysis of medical imaging data for diagnostic and research purposes. For example, a convolutional neural network (CNN) may be utilized to predict cancers tissues by learning to segment and classify regions of interest associated with cancerous tissues. For example, a diagnostic U-net may be used identify basal cell carcinoma (BCC), epidermis structures and/or adnexal structures in Mohs surgical excisions. During training, the U-Net learns to predict a binary mask indicating the presence or absence of cancerous regions for each input image. The U-Net can be trained using stochastic gradient descent (SGD) or other optimization algorithms, adjusting the network parameters to minimize the defined loss function. The U-net may be validated on a separate dataset to assess its performance and generalization ability. A performance level of the U-Net may be determined using metrics such as accuracy, precision, recall, F1-score, and area under the receiver operating characteristic (ROC) curve.

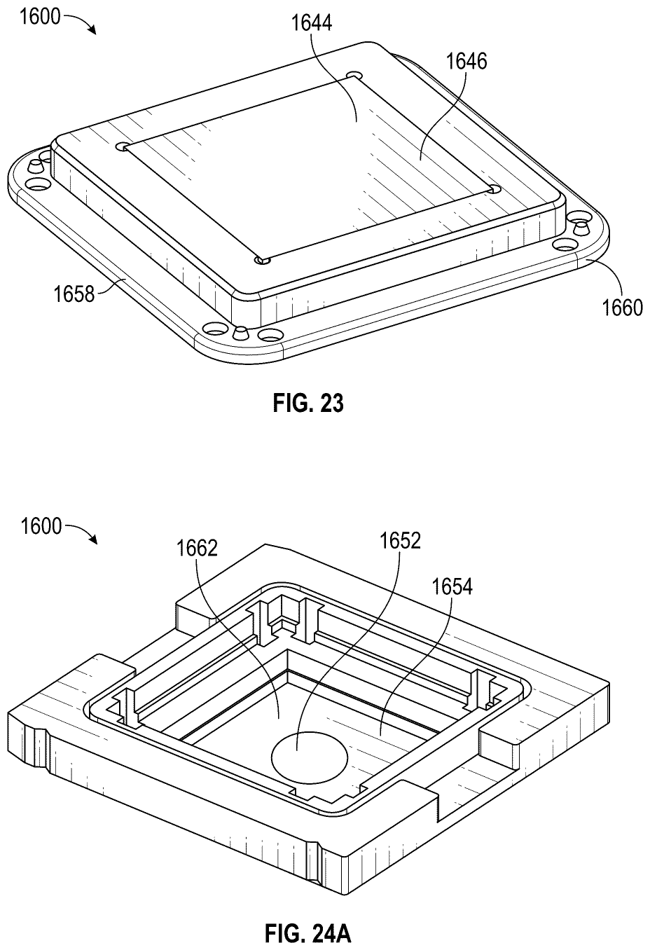

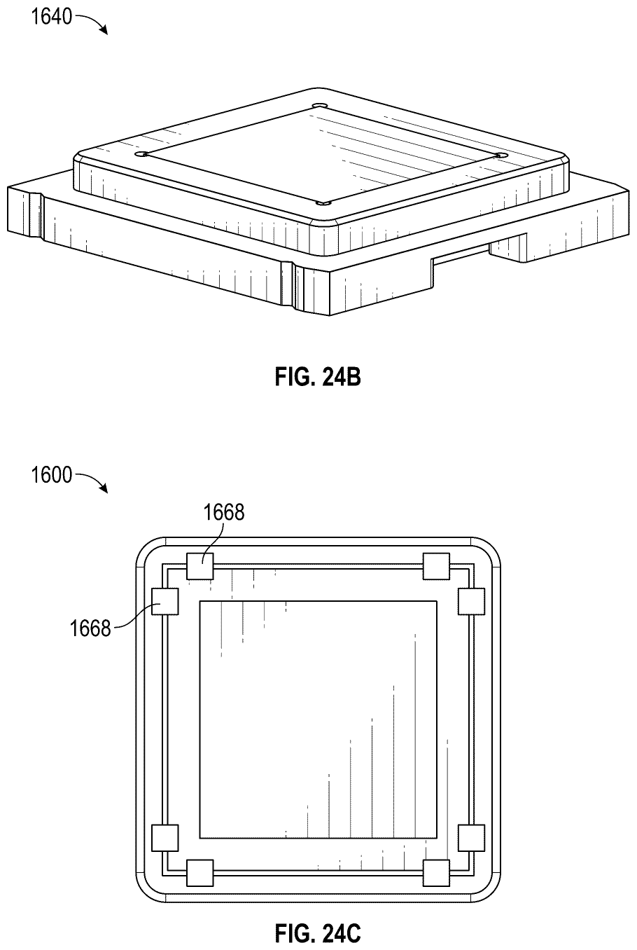

Now referring to FIGS. 23-24c, a cassette 1600 is shown. Cassette 1600 may be used with tissue staining systems 100, 900, and/or 1500. Cassette 1600 is similar in aspects to cassettes 150, 950, and 1550, and for brevity, primarily the differences will be discussed. For example, cassette 1600 may include threading 1658 and grip 1660 on an outer surface thereof, and recess 1662, gel 1654, and/or tissue 1652 housed therein. A cover 1640 may include viewing window 1644 and recess 1646. In aspects, cassette 1600 and/or cover 1640 may include magnets 1668 embedded therein, which ensure proper compression is applied to the tissue 1652. Magnets 1668 may be placed a variety of arrangements, such as along each edge and/or corner of cover 1640 and/or cassette 1600.

Certain aspects of the present disclosure may include some, all, or none of the above advantages and/or one or more other advantages readily apparent to those skilled in the art from the figures, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in aspects,” “in various aspects,” “in some aspects,” or “in other aspects” may each refer to one or more of the same or different example Aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached figures are presented only to demonstrate certain examples of the disclosure. Other elements, steps, methods, and techniques that are insubstantially different from those described above and/or in the appended claims are also intended to be within the scope of the disclosure.

What is claimed is:

1. A tissue staining system, comprising:
an upper housing including:
a first reservoir configured to retain a solution therein;
a valve attached to the first reservoir including at least one turning knob;
a first conduit configured to transport the solution; and
a funnel fluidly connected to the first conduit;
a lower housing threadedly couped to the upper housing, including:
a top cassette portion having a window;
a bottom cassette portion having a recess configured to retain a tissue therein; and
a gasket disposed along an outer perimeter of the bottom cassette portion; and
a microscope lens configured to image the tissue through the window.

2. The system of claim 1, wherein the valve is a two-way Y-valve.

3. The system of claim 1, wherein the first reservoir is configured to retain a stain solution for staining the tissue.

4. The system of claim 3, wherein a second reservoir is attached to the valve, the second reservoir configured to retain a rinse for removing excess stain solution from the tissue.

5. The system of claim 4, wherein the first reservoir is pre-filled with an acridine orange stain solution, and the second reservoir is pre-filled with a phosphate-buffered saline rinse solution.

6. The system of claim 1, further comprising a cooler configured to maintain a preset temperature within the lower housing.

7. The system of claim 1, wherein the recess includes a gel configured to adhere the tissue into the recess and maintain a position of the tissue therein, the gel including at least one of agarose, formaldehyde, or dimethyl sulfoxide.

8. The system of claim 1, wherein the top cassette portion is configured to compress the tissue along an upper surface of the bottom cassette portion.

9. The system of claim 8, wherein the window is flush with a top surface of the bottom cassette portion.

10. The system of claim 1, wherein the funnel includes a mesh guard configured to retain the tissue within the bottom housing.

11. A method of imaging tissue using a tissue staining apparatus, comprising:
filling a first reservoir and a second reservoir with a stain and a rinse, respectively;
connecting first and second housings of a tissue staining apparatus;
releasing the stain from the first reservoir via a valve, wherein the stain is configured to stain a tissue housed on the second housing of the tissue staining apparatus;
releasing the rinse from the second reservoir via the valve, wherein the rinse is configured to rinse the stained tissue;
disconnecting the first and second housings of the tissue staining apparatus;
placing a lid onto the second housing of the tissue staining apparatus to compress the stained tissue in a recess therein; and
imaging the stained tissue using a microscope.

12. The method of claim 11, wherein the valve is a two-way Y-valve.

13. The method of claim 12, wherein the valve is configured to release the stain using a first turning knob, and the valve is configured to release the rinse using a second turning knob.

14. The method of claim 13, wherein the stain is configured to flow through a first conduit, and the rinse is configured to flow through a second conduit.

15. The method of claim 11, wherein the first reservoir is filled with an acridine orange stain solution, and the second reservoir is filled with a phosphate-buffered saline rinse solution.

16. The method of claim 11, wherein the recess includes a gel configured to adhere to tissue to the recess and maintain a position of the tissue therein, the gel including at least one of agarose, formaldehyde, or dimethyl sulfoxide.

17. The method of claim 11, wherein the second housing of the tissue staining apparatus is a bottom cassette portion.

18. The method of claim 17, wherein the lid includes a window flush with a top surface of the bottom cassette portion.

19. The method of claim 11, further comprising:
inverting the tissue staining apparatus to drain the stain and the rinse back into the first and second reservoirs, respectively.

20. A tissue staining apparatus, comprising:
a first reservoir configured to retain a stain solution therein;
a second reservoir configured to retain a rinse solution therein;
a valve attached to the first and second reservoirs, the valve configured to release the stain solution through a first conduit and release the rinse solution through a second conduit; and
a cassette having a recess configured to retain a tissue therein, the cassette configured to receive the stain solution and the rinse solution.
